(19) United States
(12) Patent Application Publication
(10) Pub. No.: US 2008/0231652 A1
(43) Pub. Date: Sep. 25, 2008

(54) Printing module for large-sized UV inkjet printer

(75) Inventors: Chun-Yi Huang, Hsi Chih City (TW); Chang-Yu Wang, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: GREAT COMPUTER CORPORATION

(21) Appl. No.: 11/727,191

(22) Filed: Mar. 23, 2007

(51) Int. Cl. B41J 2/015

(52) U.S. Cl. 347/21

(57) ABSTRACT

A printing module for a large-sized UV (ultraviolet) inkjet printer includes an inkjet head device for outputting the color inks of printed figures. It is characterized in that the two sides of the inkjet head device are respectively providing with an inkjet head for outputting primer and an inkjet head for outputting varnish. Thereby, the inkjet head of primer could output under-coat before printing and the inkjet head of varnish could apply the top-coat on printed figures after printing.

### BACKGROUND OF THE INVENTION

1. Field of the Invention

The present invention is related to a printing module for a large-sized UV (ultraviolet) inkjet printer, and particularly to a printing module for a large-sized UV inkjet printer that could integrate the pre-print process and the post-print process in the original printing process to complete the process of under-coat, print and top-coat directly. It has simple structure and could lower production cost effectively and improve the printing efficiency and quality.

2. Description of the Prior Art

In the industry of the peripheral of computers or the printing, the printer almost becomes one of the basic equipments. Except for printing documents, homework and reports, the inkjet printer could apply different tones and colors on the same place by using different color inkjet cartridges by improved color inkjet technology. Thus, the print quality of the printer is close to that of photos.

In printing industry, the use of the inkjet printing machines is the trend around the world. It could print the products with small amount but numerous sorts immediately through inkjet printing machines to save time and procedure of color separation and halftone. It could have more competitiveness during this time.

However, in application of UV digital printing, the material with bad surface adhesion printed on a work is apt to fall off or be scraped off. Thus, the most way to solve it before printing is to apply a layer of primer on the printed material to be glue between printed material and inks by using additional equipment or handwork at present. This proceeding is called as a pre-printing process.

For preventing the work from being scraped off after printing or providing bright effect on surface of work, it needs to take additional equipments or handwork to apply varnish on the surface of the printed work as surface bright and anti-scrape. This proceeding is called as a post-printing process.

However, during the pre-print process (before applying inks) and the post-print process (after applying inks), it needs appropriative equipments or handwork. For use of the mass production and big-size print, the production cost and efficiency are not satisfied.

### SUMMARY OF THE INVENTION

The primary object of the present invention is to provide a printing module for a large-sized UV inkjet printer with simple structure to shorten production cost and improve efficiency and quality of print.

To achieve the above object, a printing module for a large-sized UV inkjet printer of the present invention includes an inkjet head device for outputting the color inks of printed figures. That is characterized in that the two sides of the inkjet head device are respectively disposed of an inkjet head for outputting primer and an inkjet head for outputting varnish. Thus, the inkjet head of primer could output under-coat before printing and the inkjet head of varnish could apply the top-coat on printed figures after printing.

### BRIEF DESCRIPTION OF THE DRAWINGS

FIG. 1 is a schematic view of the relative position between each inkjet heads in the printing module of an embodiment of the present invention; and

FIG. 2 is a schematic view of the embodiment of the present invention applied to a printed work when in use.

### DETAILED DESCRIPTION OF THE PREFERRED EMBODIMENT

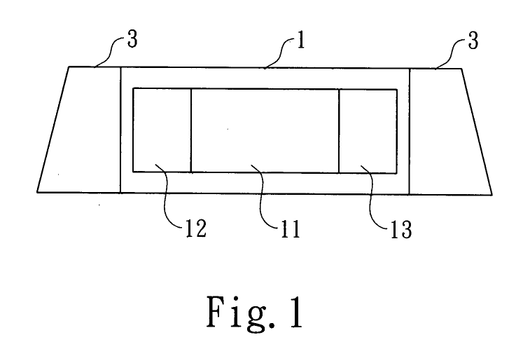

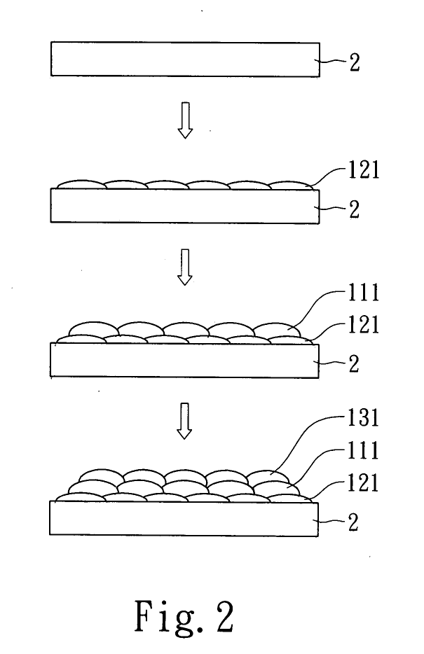

Referring to FIGS. 1 and 2, they illustrate an embodiment of the printing module for a large-sized UV inkjet printer according to the present invention.

The printing module 1 includes an inkjet head device 11 for outputting color inks 111 which would be printed on figures. Wherein, the two sides of the inkjet head device 11 are respectively disposed of an inkjet head 12 for outputting primer 121 (under-coat) and an inkjet head 13 for outputting varnish 131 (top-coat). The inkjet head 12 for outputting primer 121 and the inkjet head 13 for outputting varnish 131 are controlled by the printing module 1 to output inks.

Further, before printing, users could advancedly control the printing module 1 to render the inkjet head 12 for outputting primer 121 disposed on one side of the inkjet head device 11 with color inks 111 of the printing module 1 to output primer 121 on a printed work 2. After the primer 121 is outputted, the inks could dry faster by being lightened from UV light 3 disposed on two sides of the printing module 1. Then, the inkjet head device 11 with color inks 111 is controlled by printing module 1 to output pre-determined figures. Finally, the inkjet head 13 for outputting varnish 131 disposed on one side of the inkjet head device 11 controlled by the printing module 1 applies varnish 131 to make surface bright and prevent finished work from being scraped off.

Thus, the printing module 1 of the present invention could complete under-coat, print and top-coat during a digital printing process. Compared to the prior art that needs appropriative equipments or handwork to handle the pre-print process (before applying inks) and the post-print process (after applying inks), the present invention could lower production cost effectively and higher efficiency and quality of print on use of the mass production and big-size print.

As stated in the above disclosed, the present invention can surely achieve its expected objects to provide a printing module for a large-sized UV inkjet printer with simple structure to lower production cost and improve efficiency and quality of print. It has its industrial practical value.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A printing module for a large-sized UV (ultraviolet) inkjet printer, comprising an inkjet head device for outputting the color inks of printed figures, being characterized in that:
the two sides of the inkjet head device respectively are providing with an inkjet head for outputting primer and an inkjet head for outputting varnish; thereby, the inkjet head of primer outputs under-coat before printing and the inkjet head of varnish applies the top-coat on printed figures after printing.

2. The printing module for the large-sized UV inkjet printer as claimed in claim 1, wherein the inkjet head for outputting primer and the inkjet head for outputting varnish are controlled to output by the printing module.
